(19) United States
(12) Patent Application Publication
(10) Pub. No.: US 2026/0037830 A1
(43) Pub. Date: Feb. 5, 2026

(54) DYNAMIC SUPERNET LEARNING APPARATUS AND METHOD FOR NEURAL ARCHITECTURE SEARCH

(71) Applicant: UIF (University Industry Foundation), Yonsei University, Seoul (KR)

(72) Inventors: Bumsub HAM, Seoul (KR); Jeimin JEON, Seoul (KR); Youngmin OH, Seoul (KR); Junghyup LEE, Seoul (KR); Donghyeon BAEK, Seoul (KR); Dohyung KIM, Goyang-si (KR); Chanho EOM, Seoul (KR)

(21) Appl. No.: 18/799,660

(22) Filed: Aug. 9, 2024

(30) Foreign Application Priority Data
Jul. 30, 2024 (KR) 10-2024-0100942

(51) Int. Cl. G06N 3/0985

(52) U.S. Cl. CPC G06N 3/0985

(57) ABSTRACT

The disclosed embodiment provides a supernet learning apparatus and method that can accurately compare each subnet based on performance when searching for a neural architecture by performing learning by adjusting the learning rate according to the complexity of each subnet extracted from the supernet, by performing the steps of analyzing the complexity of a subnet repeatedly extracted from the supernet, and setting a learning rate that is dynamically variable according to the number of learning repetitions based on the complexity analyzed in the extracted subnet, learning the extracted subnet using the learning rate that is set to be variable according to the number of learning repetitions, and merging the trained subnet into the supernet to obtain a trained supernet.

### CROSS-REFERENCE TO RELATED APPLICATIONS

This application claims priority under 35 U.S.C. § 119 (a) to Korean Patent Application No. 10-2024-0100942, filed on Jul. 30, 2024, with the Korean Intellectual Property Office, the disclosure of which is incorporated herein in its entirety by reference.

### BACKGROUND

### 1. Technical Field

The present disclosure relates to a supernet learning apparatus and method, and more particularly to a dynamic supernet learning apparatus and method for neural architecture search.

### 2. Description of the Related Art

Neural Architecture Search (NAS) refers to a technology that automatically searches for the optimal neural architecture on target hardware and data sets.

FIG. 1 is a diagram for explaining the concept of neural architecture search. As shown in FIG. 1, neural architecture search refers to a technique for selecting a neural network that can exhibit the highest performance among multiple candidate neural networks within a search space defined by predefined target hardware and data sets. In other words, the search space can be predefined by available computing resources, etc. In addition, multiple candidate neural networks can be neural networks designed differently from each other in terms of the number of layers, the size of the filter (also called kernel) of each layer, the number of channels, the type of function, or the like.

Initially, neural architecture search was performed by training multiple candidate neural networks in the search space, checking the performance of each trained candidate neural network, and performing reinforcement learning or evolutionary algorithms using the checked performance as a reward. However, there is a problem that training each of the multiple candidate neural networks requires considerable time and cost.

Accordingly, a one-shot learning-based neural architecture search method has also been proposed, which constructs a supernet in which each of multiple candidate neural networks can be defined as a sub-path, and trains the constructed supernet only once to check the performance of multiple candidate neural networks defined as each sub-path.

FIG. 2 is a diagram to explain the concept of a one-shot learning method for a supernet. In FIG. 2, as in FIG. 1, each edge connecting two nodes, i.e., a sub-path, is an operation layer that performs a specified neural network operation.

The one-shot learning method improves the efficiency of the search process through the weight sharing method. Specifically, in the one-shot learning method, as shown on the left side of FIG. 2, a supernet is constructed that includes all subnets in the search space. Then, the constructed supernet is trained. At this time, the learning of the supernet is performed, as shown on the right side of FIG. 2, by sampling and extracting some subnets that constitute the supernet, training the extracted subnets, and then merging them into the supernet, thereby training the entire supernet once. That is, even if the weights of the subnets are trained by selecting different combinations, the one-shot learning method reduces the learning time of the entire supernet by sharing and utilizing the weights updated by learning in other subnets.

In addition, when searching for a neural architecture based on a supernet, the performance of various combinations of subnets is checked from the trained supernet, and the subnet with the best performance is selected as the optimal neural architecture. In other words, in the one-shot learning-based neural architecture search method, the optimal subnet is efficiently found by predicting the performance of each of the multiple subnets according to various combinations based on the trained supernet.

However, since the supernet itself is constructed in a very large size where each of the multiple candidate neural networks can be defined as a sub-path, the number of subnets is very large. For example, in a search space such as MobileNet, the number of subnets extracted may be 721. If all the subnets extracted and trained in such a large number share weights in one supernet, it can cause interference between the subnet weights, which can cause inaccurate performance predictions for each subnet. Accordingly, a few-shot learning method has also been proposed, which divides a supernet into several sub-supernets and trains the divided sub-supernets in the same way as supernet learning.

In this one-shot or few-shot learning method for a supernet, learning is performed under the same conditions for all sampled and extracted subnets. This is to provide learning equality for multiple extracted subnets. In other words, subnets trained under the same conditions are compared with each other to search for the optimal subnet. However, the composition of multiple subnets is not the same. Therefore, learning under the same conditions for multiple subnets rather becomes a factor that prevents the optimal subnet from being searched when searching for a neural architecture.

### SUMMARY OF THE INVENTION

An object of the present disclosure is to provide a supernet learning apparatus and method capable of performing accurate neural architecture search.

Another object of the present disclosure is to a supernet learning apparatus and method that performs learning by dynamically adjusting a learning rate according to the complexity of each subnet extracted from a supernet, thereby enabling comparison of each subnet based on performance.

According to one embodiment of the present disclosure, a supernet learning apparatus is an apparatus including: a memory; and a processor that executes at least a part of operations according to a program stored in the memory, wherein the processor performs the steps of analyzing the complexity of a subnet repeatedly extracted from the supernet, and setting a learning rate that is dynamically variable according to the number of learning repetitions based on the complexity analyzed in the extracted subnet, learning the extracted subnet using the learning rate that is set to be variable according to the number of learning repetitions, and merging the trained subnet into the supernet to obtain a trained supernet.

The processor may analyze the complexity based on the number of weights included in a plurality of operation layers constituting the subnet.

The processor may be configured to adjust the learning rate to gradually decrease as the number of learning repetitions increases, but the size of the decrease can be adjusted differently depending on the complexity of the extracted subnet.

The processor may set the learning rate to decrease slowly with an increase in the number of learning repetitions when the complexity of the extracted subnet is relatively high based on the specified maximum complexity and minimum complexity, and may set the learning rate to decrease quickly with an increase in the number of learning repetitions when the complexity of the selected subnet is relatively low.

The processor may calculate a learning reduction coefficient that controls the speed of decrease of a learning rate for the subnet according to the complexity of the extracted subnet, and dynamically adjust and set the learning rate according to the number of learning repetitions using the learning reduction coefficient.

The processor may divide the supernet into multiple sub-supernets, extract the subnets from each of the divided multiple sub-supernets, and when the extracted subnets are trained, merge the trained subnets to obtain multiple trained sub-supernets, and merge the trained multiple sub-supernets again to obtain the trained supernet.

According to another embodiment of the present disclosure, a supernet learning method includes the steps of: analyzing the complexity of a subnet repeatedly extracted from the supernet, and setting a learning rate that is dynamically variable according to the number of learning repetitions based on the complexity analyzed in the extracted subnet; learning the extracted subnet using the learning rate that is set to be variable according to the number of learning repetitions; and merging the trained subnet into the supernet to obtain a trained supernet.

The supernet learning apparatus and method of the present disclosure perform learning by dynamically adjusting a learning rate according to the complexity of each subnet extracted from a supernet, thereby enabling accurate comparison of each subnet based on performance when searching for a neural architecture.

### BRIEF DESCRIPTION OF THE DRAWINGS

FIG. 1 is a diagram for explaining the concept of neural architecture search.

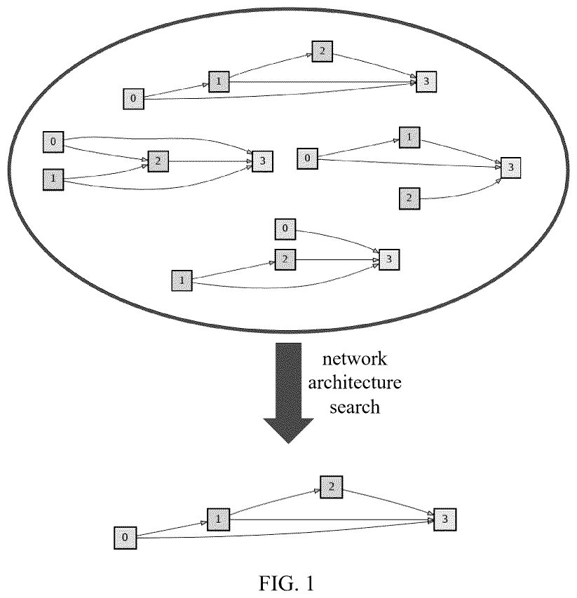

FIG. 2 is a diagram for explaining the concept of one-shot learning method for supernet.

FIG. 3 shows the results of comparing the complexity and accuracy of subnets.

FIG. 4 shows a configuration of a neural architecture search system including a supernet learning apparatus according to an embodiment, roughly divided by operation.

FIG. 5 shows a change in learning rate according to a learning reduction coefficient.

FIG. 6 shows a supernet learning method according to an embodiment.

FIG. 7 is a diagram for explaining a computing environment including a computing device according to an embodiment.

### DETAILED DESCRIPTION OF THE INVENTION

Hereinafter, specific embodiments according to the embodiments of the present disclosure will be described with reference to the drawings. The following detailed description is provided to assist in a comprehensive understanding of the methods, devices and/or systems described herein. However, this is only an example and the present invention is not limited thereto.

In describing the embodiments, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice or the intention of a user or operator. Thus, the definitions should be determined based on the overall content of the present specification. The terms used herein are only for describing the embodiments, and should not be construed as limitative. Unless the context clearly indicates otherwise, the singular forms are intended to include the plural forms as well. It should be understood that the terms “comprises,” “comprising,” “includes,” and “including,” when used herein, specify the presence of stated features, numerals, steps, operations, elements, or combinations thereof, but do not preclude the presence or addition of one or more other features, numerals, steps, operations, elements, or combinations thereof. Also, terms such as “unit”, “device”, “module”, “block”, and the like described in the specification refer to units for processing at least one function or operation, which may be implemented by hardware, software, or a combination of hardware and software.

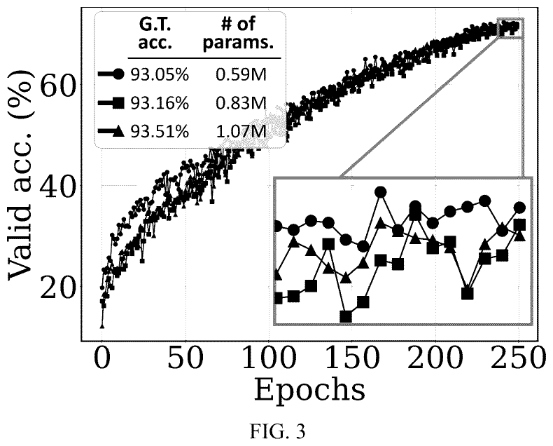

FIG. 3 shows the results of comparing the complexity and accuracy of subnets.

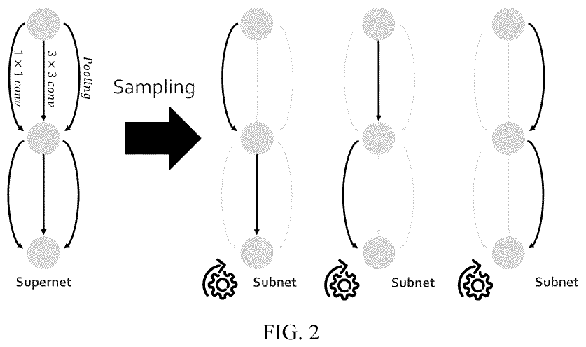

As described above, since multiple subnets are randomly sampled and extracted from the supernet, the configuration of the operation layers included in each extracted subnet is also different from each other. As an example, as in FIG. 2, if among the three edges (or sub-paths) connecting two nodes, the left edge is an operation layer that performs a 1×1 convolution (1×1 conv) operation, the middle edge is an operation layer that performs a 3×3 convolution (3×3 conv) operation, and the right edge is an operation layer that performs a pooling operation, the operation complexity of each operation layer is different from each other. Here, the complexity for each subnet may be the number of weights in all operation layers included in the subnet. That is, the more weights included in the subnet, the more operations must be performed, so the higher the complexity.

In addition, when learning is performed in the same way for neural networks with different complexities, neural networks with low complexity may learn well and show excellent performance, while neural networks with high complexity may not learn sufficiently and show low performance.

FIG. 3 shows the results of measuring the accuracy according to the number of learning repetitions (epochs) for multiple subnets extracted from the supernet. FIG. 3 shows the accuracy of each subnet when learning is repeated up to 250 times for subnets with weights of 590,000 (0.59 M), 830,000 (0.83 M), and 1.07 million (1.07 M), respectively. Looking at FIG. 3, the accuracy of each trained subnet increases with the number of learning repetitions, but there is a difference in the accuracy. In particular, when learning is repeated up to 250 times, as shown in the enlarged diagram on the lower right, the subnet with the lowest complexity of 590,000 (0.59 M) weights shows the best accuracy, followed by the subnet with the next highest complexity of 830,000 (0.83 M) weights, while the subnet with the highest complexity of 1.07 million (1.07 M) weights shows the lowest accuracy.

However, as shown in the upper left, in the truth accuracy (G.T.acc.) measured by sufficiently training all three subnets, the subnet with the highest complexity of 1.07 million (1.07 M) weights has the highest accuracy of 93.51%, the subnet with the next highest complexity of 830,000 (0.83 M) weights has a lower accuracy of 93.16%, and the subnet with 590,000 (0.59 M) weights has the lowest accuracy of 93.05%. In other words, the accuracy rankings for multiple subnets can vary greatly depending on the complexity and number of learning cycles of each subnet.

Therefore, training a supernet by performing learning under the same learning conditions by equalizing the conditions between the subnets, without considering the complexity of each subnet, actually causes an error of selecting a subnet with lower performance as the neural architecture. In other words, the intention to fairly search for subnets may actually result in causing an unfairness problem regarding the performance of each subnet, which may cause an error in the neural architecture search.

Accordingly, here, each extracted subnet is trained differently according to complexity so that neural architecture search can be performed based only on the pure performance of each subnet.

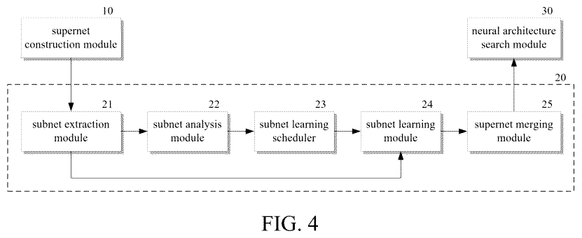

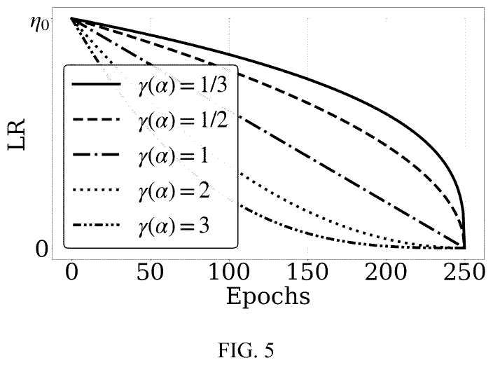

FIG. 4 shows a configuration of a neural architecture search system including a supernet learning apparatus according to an embodiment, roughly divided by operation, and FIG. 5 shows a change in learning rate according to a learning reduction coefficient.

Referring to FIG. 4, the neural architecture search system may include a supernet construction module 10, a supernet learning apparatus 20, and a neural architecture search module 30.

The supernet construction module 10 constructs a supernet that includes all subnets within the search space, as before. Here, each of the multiple subnets can be a candidate neural network within the search space defined by the predefined target hardware and data set as described above, and can be a neural network designed differently from each other in terms of the number of layers, the size of the filter (or kernel) of each layer, the number of channels, the type of function, or the like.

The technique by which the supernet construction module 10 constructs the supernet is a known technology and therefore is not described in detail here.

When a supernet is constructed by the supernet construction module 10, the supernet learning apparatus 20 extracts subnets from the supernet and repeats the process of performing learning on each extracted subnet. Here, the supernet learning apparatus 20 of one embodiment analyzes the complexity of each repeatedly extracted subnet and performs learning by adjusting the learning rate (LR) (η) so that learning is performed differently according to the analyzed complexity.

The supernet learning apparatus 20 may include a subnet extraction module 21, a subnet analysis module 22, a subnet learning scheduler 23, a subnet learning module 24, and a supernet merging module 25.

The subnet extraction module 21 receives the supernet constructed in the supernet construction module 10 and extracts the subnets. The subnet extraction module 21 may extract one different subnet for each repeated learning according to the specified total number of learning repetitions T, rather than extracting subnets according to all combinations that can be extracted from the supernet. At this time, the subnets may be extracted in different combinations so that the multiple operation layers that construct the supernet are included in the extracted subnets at least once. In addition, each operation layer may be included in a different subnet as much as possible.

However, since interference between the weights of the subnets may occur when multiple subnets share the weights of a single supernet according to the one-shot learning method, resulting in inaccurate prediction of the performance of the subnets, it is also possible to divide the supernet into multiple sub-supernets according to the few-shot learning method, and then extract multiple subnets from each of the multiple divided sub-supernets.

The method by which the subnet extraction module 21 extracts subnets from the supernet can be changed in various ways, and since it is a known technology, a detailed description is omitted here.

The subnet analysis module 22 obtains the subnet complexity C(α) based on the number of weights included in the subnet α extracted from the subnet extraction module 21. The subnet analysis module 22 can obtain the complexity C(α) by accumulating the number of weights included in each of the multiple operation layers constructing the extracted subnet α, for example.

The subnet learning scheduler 23 adjusts the learning rate η applied during repeated learning for the extracted subnet α, based on the complexity C(α) obtained from the subnet analysis module 22. In particular, in one embodiment, the subnet learning scheduler 23 may adjust the learning rate η to gradually decrease while performing repeated learning for the supernet, and may adjust the amount of decrease in the learning rate η differently depending on the complexity C(α) of the subnet α extracted differently for each repeated learning. That is, the learning rate η is dynamically varied depending on the complexity C(α) of the extracted subnet α along with the current number of learning repetition t among the total number of learning repetitions T for the supernet.

Specifically, the subnet learning scheduler 23 may adjust the learning rate η₁ according to the number of learning repetitions t as in Equation 1.

$${η}^{t} = {η}^{0} \cdot {( 1 - \frac{t}{T} )}^{γ ( α )} \qquad [ Equation 1 ]$$

where, T represents the total number of learning repetitions, t (a natural number with t≤T) represents the current number of learning repetitions, η⁰ represents the initial learning rate, and γ(α) represents the learning reduction coefficient for the subnet α.

Since the item

$$( 1 - \frac{t}{T} )$$

in Equation 1 has a value less than 1, it can be seen that the learning rate η^{t} basically gradually decreases as the number of learning repetitions t increases. As shown in FIG. 5, when the learning reduction coefficient γ(α) is 1, the learning rate n′ decreases linearly in proportion to the number of learning repetitions t. This can be called the reference learning rate.

However, when the learning reduction coefficient γ(α) is greater than 1 (here, for example, γ(α)=2, 3), the learning rate η₁ decreases rapidly in the early stages of learning, and gradually decreases more slowly as the number of repetitions t increases. On the other hand, when the learning reduction coefficient γ(α) is less than 1 (here, for example, γ(α)=½, ⅓), the learning rate η^{t} decreases slowly in the early stages of learning, but gradually decreases more rapidly as the number of repetitions t increases. That is, the learning rate η^{t} according to each number of repetitions t can gradually decrease by different amounts by the learning reduction coefficient γ(α).

In addition, in Equation 1, the learning reduction coefficient γ(α) is a value for the complexity C(α) of the extracted subnet α and can be calculated according to Equation 2.

$$γ ( α ) = ωlog ( 𝒞 ( α ) ) + τ \qquad [ Equation 2 ]$$

where, ω and τ represent the normalization weight and bias, which can be calculated as in Equations 3 and 4, respectively.

$$ω = - \frac{{γ}_{max} - {γ}_{min}}{log ( {𝒞}_{max} ) - log ( {𝒞}_{min} )} \qquad [ Equation 3 ]$$

$$τ = {γ}_{min} - ωlog ( {𝒞}_{max} ) \qquad [ Equation 4 ]$$

where, Cₘₐₓ and Cₘᵢₙ represent the maximum complexity and minimum complexity, and γₘₐₓ and γₘᵢₙ are hyperparameters representing the maximum learning reduction coefficient and minimum learning reduction coefficient set for the learning reduction coefficient γ(α) at minimum complexity Cₘᵢₙ and maximum complexity Cₘₐₓ, respectively.

The maximum complexity Cₘₐₓ and minimum complexity Cₘᵢₙ of the subnet can be determined in advance by the search space for constructing the supernet. For example, considering the supernet of FIG. 2, the minimum complexity Cₘᵢₙ can be obtained as the number of weights of the subnet composed only of the pooling layer with the smallest number of weights, and the maximum complexity Cₘₐₓ can be obtained as the number of weights of the subnet composed only of the 3×3 convolution operation layer with the largest number of weights. In addition, the hyperparameters, the maximum learning reduction coefficient γₘₐₓ and the minimum learning reduction coefficient γₘᵢₙ, can be set to 3 and ⅓, respectively, for example.

As shown in Equation 3, the normalization weight ω is calculated as the ratio of the difference (γₘₐₓ−γₘᵢₙ) between the maximum learning reduction coefficient γₘₐₓ and the minimum learning reduction coefficient γₘᵢₙ to the logarithmic difference (log(Cₘₐₓ)−log(Cₘᵢₙ)) of the maximum complexity Cₘₐₓ and the minimum complexity Cₘᵢₙ of the subnet. In addition, the normalization bias τ represents the bias component obtained by subtracting the normalized maximum complexity (ωlog(Cₘₐₓ)) from the set minimum learning reduction coefficient γₘᵢₙ.

Although the normalization weight ω has a negative value according to Equation 3, the learning reduction coefficient γ(α) in Equation 2 has a positive value as the normalization bias τ is added.

As described above, the maximum complexity Cₘₐₓ and the minimum complexity Cₘᵢₙ can be preset and acquired by the subnet analysis module 22, and the maximum learning reduction coefficient γₘₐₓ and the minimum learning reduction coefficient γₘᵢₙ are preset hyperparameters. Therefore, the normalization weight ω and the normalization bias τ can be calculated and determined in advance when the maximum complexity Cₘₐₓ and the minimum complexity Cₘᵢₙ are acquired by the subnet analysis module 22.

According to Equation 2, the learning reduction coefficient γ(α) is obtained by normalizing and biasing the complexity C(α) of each extracted subnet α based on the specified maximum complexity Cₘₐₓ and minimum complexity Cₘᵢₙ. In other words, the learning reduction coefficient γ(α) can be said to be a speed control parameter that controls the speed of the learning rate η^{t} decrease according to the relative complexity of the subnet α with respect to the maximum complexity Cₘₐₓ and minimum complexity Cₘᵢₙ.

Accordingly, the learning rate η^{t} calculated by Equation 1 is adjusted to decrease rapidly or slowly according to the learning reduction coefficient γ(α) as the number of learning repetitions t increases. Specifically, the higher the complexity C(α) of the subnet α, the more the learning reduction coefficient γ(α) decreases relatively, while the lower the complexity C(α) of the subnet α, the more the value of the learning reduction coefficient γ(α) increases relatively.

As a result, as shown in FIG. 5, the learning rate η^{t} gradually decreases as the number of learning repetitions t increases, but when the complexity C(α) of the extracted subnet α is high, the learning rate η^{t} is set to decrease slowly, whereas when the complexity C(α) is low, the learning rate η^{t} is set to decrease quickly. In other words, the learning efficiency of the subnet α with high complexity C(α) is increased.

The subnet learning module 24 trains each subnet α extracted from the subnet extraction module 21. The subnet learning module 24 trains a subnet α extracted again from the subnet extraction module 21 at each repetition of learning. That is, a different subnet α is selected and trained at each repetition of learning. At this time, the subnet learning module 24 may perform learning based on the learning rate η^{t} adjusted by the subnet learning scheduler 23 according to the number of learning repetitions t based on the complexity C(α) of the subnet α.

As a result, the subnet learning module 24 performs learning while dynamically adjusting the update rate of the weights included in the currently extracted subnet α by applying a learning rate η^{t} that varies according to the number of learning repetitions t.

As described above, when the complexity C(α) of the subnet (α) extracted at the current number of learning repetition t is high, the learning rate η^{t} decreases less compared to the previous number of repetition (t−1), whereas when the complexity C(α) of the subnet α is low, the learning rate η^{t} decreases more compared to the previous number of repetition (t−1).

Therefore, as shown in FIG. 5, when the extracted subnet α with high complexity C(α) is repeatedly extracted, the weights can be effectively updated until the latter half of the learning when the number of learning repetitions t approaches the total number of learning repetitions T. On the other hand, when the complexity C(α) of the extracted subnet (α) is low, the learning rate η₁ decreases very quickly as the number of learning repetitions t increases.

As a result, the subnet learning module 24 performs learning based on a learning rate η₁ that is dynamically adjusted according to the complexity C(α) of the subnet α, so that learning is performed at a fair level for both the subnet α with high complexity C(α) and the subnet a with low complexity C(α).

The supernet merging module 25 receives the subnet α extracted from the supernet and trained by the subnet learning module 24, and merges it back into the supernet. The supernet merging module 25 receives the different trained subnets α extracted repeatedly for the total number of learning repetitions T, and merges them to obtain the trained supernet.

At this time, if few-shot learning is applied instead of one-shot learning, and the subnet extraction module 21 divides the supernet into multiple sub-supernets and extracts subnets from the divided sub-supernets, the supernet merging module 25 may merge the subnets to first reconstruct the sub-supernet, and then merge the reconstructed sub-supernets again to obtain the supernet.

Meanwhile, once the learning on the supernet is completed by the supernet learning apparatus 20, the neural architecture search module 30 extracts various combinations of subnets from the trained supernet, checks the performance of the extracted subnets, and obtains the subnet with the best performance as the optimal neural architecture.

As a result, a dynamic supernet learning apparatus for neural architecture search according to one embodiment performs learning by dynamically adjusting a learning rate according to the complexity of each subnet extracted from a supernet, thereby enabling accurate comparison of each subnet based on performance during neural architecture search.

In the illustrated embodiment, respective configurations may have different functions and capabilities in addition to those described above, and may include additional configurations not described. In addition, in one embodiment, each configuration may be implemented using one or more physically separated devices, or may be implemented by one or more processors, or a combination of one or more processors and software, and may not be clearly distinguished in specific operations unlike the illustrated example.

In addition, the supernet learning apparatus shown in FIG. 4 may be implemented in a logic circuit by hardware, firm ware, software, or a combination thereof, or may be implemented using a general purpose or special purpose computer. The apparatus may be implemented using hardwired device, field programmable gate array (FPGA) or application specific integrated circuit (ASIC). Further, the apparatus may be implemented with a system on chip (SoC) including one or more processors and a controller.

In addition, the supernet learning apparatus may be mounted in a computing device or server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

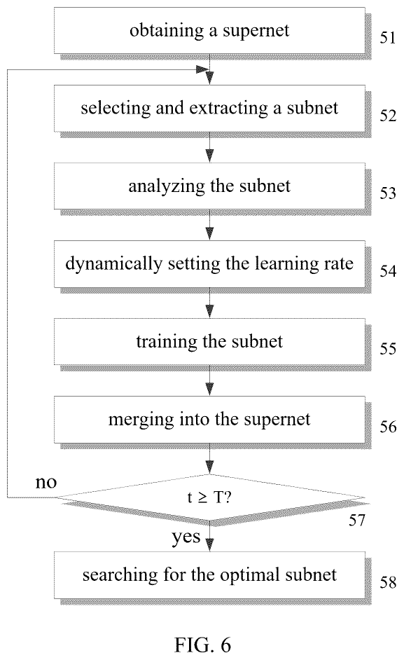

FIG. 6 shows a supernet learning method according to an embodiment.

Referring to FIG. 6, the supernet learning method first obtains a supernet composed of all subnets within the search space (51) Then, one subnet α is selected and extracted from the obtained supernet (52). The subnet (α) may be randomly extracted from the supernet.

When the subnet α is extracted, the complexity C(α) of the extracted subnet α is checked (53). Here, the complexity C(α) may be calculated as the cumulative sum of the number of weights included in each of the multiple operation layers that constitute the extracted subnet α.

When the complexity C(α) for the subnet α is checked, the learning rate η^{t} that dynamically varies according to the number of learning repetitions t in the designated total number of learning repetitions T is set (54). Here, the learning rate η^{t} may be set to be adjusted according to the complexity C(α) of the subnet α and the number of learning repetitions t, as shown in Equations 1 to 4. For example, when the complexity C(α) is high, the learning rate η¹ may be set to decrease slowly as the number of learning repetitions t increases, and when the complexity C(α) is low, the learning rate η₁ may be set to decrease quickly as the number of learning repetitions t increases.

When the learning rate η^{t} is set, learning is performed on the extracted subnet α (55). Here, learning on the subnet α can be performed in a specified manner according to the neural network model that constructs the supernet. Then, the trained subnet α is merged into the supernet (56). At this time, if the supernet is divided into multiple sub-supernets, the subnet a may be merged into the sub-supernet.

Afterwards, it is determined whether the number of subnets α extracted from the supernet and trained, that is, the number of learning repetitions t, is greater than or equal to the specified total number of learning repetitions T (57). If the number of learning repetitions t is less than the total number of learning repetitions T, another subnet is selected and extracted from the supernet again (52). However, if the number of learning repetitions t is greater than or equal to the specified total number of learning repetitions T, it is determined that learning for the supernet is complete, and no additional subnets α are extracted. Afterwards, various combinations of subnets are extracted from the trained supernet, and the performance of the extracted multiple subnets is compared to obtain the subnet with the best performance as the optimal neural architecture (58).

In FIG. 6, it is described that respective processes are sequentially executed, which is, however, illustrative, and those skilled in the art may apply various modifications and changes by changing the order illustrated in FIG. 6 or performing one or more processes in parallel or adding another process without departing from the essential gist of the exemplary embodiment of the present disclosure.

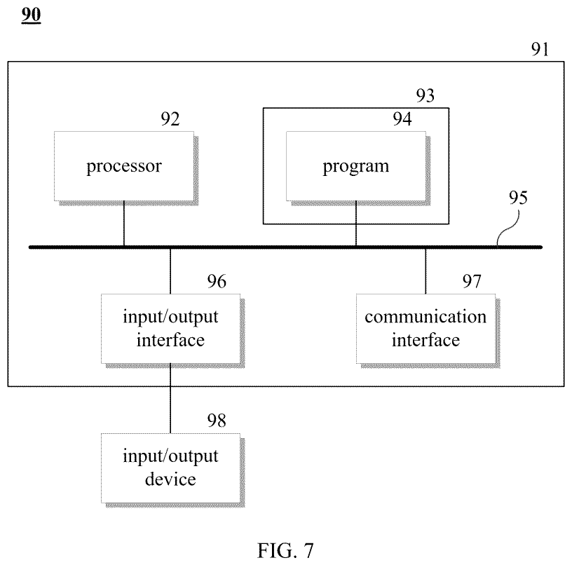

FIG. 7 is a diagram for explaining a computing environment including a computing device according to an embodiment.

In the illustrated embodiment, respective configurations may have different functions and capabilities in addition to those described below, and may include additional configurations in addition to those described below. The illustrated computing environment 90 may include a computing device 91 to perform the supernet learning method illustrated in FIG. 6. In an embodiment, the computing device 91 may be one or more components included in the supernet learning apparatus shown in FIG. 4.

The computing device 91 includes at least one processor 92, a computer readable storage medium 93 and a communication bus 95. The processor 92 may cause the computing device 91 to operate according to the above-mentioned exemplary embodiment. For example, the processor 92 may execute one or more programs 94 stored in the computer readable storage medium 93. The one or more programs 94 may include one or more computer executable instructions, and the computer executable instructions may be configured, when executed by the processor 92, to cause the computing device 91 to perform operations in accordance with the exemplary embodiment.

The communication bus 95 interconnects various other components of the computing device 91, including the processor 92 and the computer readable storage medium 93.

The computing device 91 may also include one or more input/output interfaces 96 and one or more communication interfaces 97 that provide interfaces for one or more input/output devices 98. The input/output interfaces 96 and the communication interfaces 97 are connected to the communication bus 95. The input/output devices 98 may be connected to other components of the computing device 91 through the input/output interface 96. Exemplary input/output devices 98 may include input devices such as a pointing device (such as a mouse or trackpad), keyboard, touch input device (such as a touchpad or touchscreen), voice or sound input device, sensor devices of various types and/or photography devices, and/or output devices such as a display device, printer, speaker and/or network card. The exemplary input/output device 98 is one component constituting the computing device 91, may be included inside the computing device 91, or may be connected to the computing device 91 as a separate device distinct from the computing device 91.

The present invention has been described in detail through a representative embodiment, but those of ordinary skill in the art to which the art pertains will appreciate that various modifications and other equivalent embodiments are possible. Therefore, the true technical protection scope of the present invention should be defined by the technical spirit set forth in the appended scope of claims.

What is claimed is:

1. A supernet learning apparatus comprising:
a memory; and
a processor that executes at least a part of operations according to a program stored in the memory,
wherein the processor performs the steps of:
analyzing a complexity of a subnet repeatedly extracted from a supernet, and setting a learning rate that is dynamically variable according to a number of learning repetitions based on the complexity analyzed in the subnet,
learning the subnet using the learning rate that is set to be variable according to the number of learning repetitions, and
merging the subnet into the supernet to obtain a trained supernet.

2. The supernet learning apparatus according to claim 1,
wherein the processor analyzes the complexity based on a number of weights included in a plurality of operation layers constituting the subnet.

3. The supernet learning apparatus according to claim 1,
wherein the processor is configured to adjust the learning rate to gradually decrease as the number of learning repetitions increases, but a size of the decrease is adjusted differently depending on the complexity of the subnet.

4. The supernet learning apparatus according to claim 1,
wherein the processor
sets the learning rate to decrease slowly with an increase in the number of learning repetitions when the complexity of the subnet is relatively high based on maximum complexity and minimum complexity, and
sets the learning rate to decrease quickly with an increase in the number of learning repetitions when the complexity of the subnet is relatively low.

5. The supernet learning apparatus according to claim 1,
wherein the processor
calculates a learning reduction coefficient that controls speed of decrease of the learning rate for the subnet according to the complexity of the subnet, and
dynamically adjusts and sets the learning rate according to the number of learning repetitions using the learning reduction coefficient.

6. The supernet learning apparatus according to claim 5,
wherein the processor sets the learning rate η^{t} according to Equation
$${η}^{t} = {η}^{0} \cdot {( 1 - \frac{t}{T} )}^{γ ( α )}$$
where, T represents a total number of learning repetitions, t represents the number of learning repetitions, n⁰ represents an initial learning rate, and γ(α) represents the learning reduction coefficient.

7. The supernet learning apparatus according to claim 5,
wherein the processor calculates the learning reduction coefficient γ(α) according to the complexity C(α) of the subnet α according to Equation
$$γ ( α ) = ωlog ( 𝒞 ( α ) ) + τ$$
where, ω and τ represent normalization weight and normalization bias.

8. The supernet learning apparatus according to claim 7,
wherein the processor calculates the normalization weight ω according to Equation
$$ω = - \frac{{γ}_{max} - {γ}_{min}}{log ( {𝒞}_{max} ) - log ( {𝒞}_{min} )}$$
where, Cₘₐₓ and Cₘᵢₙ represent the maximum complexity and minimum complexity of subnets being extracted, and γₘₐₓ and γₘᵢₙ represent the maximum learning reduction coefficient and minimum learning reduction coefficient set for the learning reduction coefficient.

9. The supernet learning apparatus according to claim 7,
wherein the processor calculates the normalization bias τ according to Equation
$$τ = {γ}_{min} - ωlog ( {𝒞}_{max} )$$
where, Cₘₐₓ represents the maximum complexity among the complexities of extracted multiple subnets, and γₘᵢₙ represents the minimum learning reduction coefficient set for the learning reduction coefficient.

10. The supernet learning apparatus according to claim 1,
wherein the processor
divides the supernet into multiple sub-supernets, extract subnets from each of the divided multiple sub-supernets, and
when the extracted subnets are trained, merges the trained subnets to obtain multiple trained sub-supernets, and merges the multiple trained sub-supernets again to obtain the trained supernet.

11. A supernet learning method performed by a processor, the method including the steps of:
analyzing a complexity of a subnet repeatedly extracted from a supernet, and setting a learning rate that is dynamically variable according to a number of learning repetitions based on the complexity analyzed in the subnet;
learning the subnet using the learning rate that is set to be variable according to the number of learning repetitions; and
merging the subnet with the supernet to obtain a trained supernet.

12. The supernet learning method according to claim 11,
wherein the step of setting a learning rate includes analyzing the complexity based on a number of weights included in a plurality of operation layers constituting the subnet.

13. The supernet learning method according to claim 11,
wherein the step of setting a learning rate includes adjusting the learning rate to gradually decrease as the number of learning repetitions increases, but a size of the decrease is adjusted differently depending on the complexity of the subnet.

14. The supernet learning method according to claim 11,
wherein the step of setting a learning rate includes
setting the learning rate to decrease slowly with an increase in the number of learning repetitions when the complexity of the subnet is relatively high based on the specified maximum complexity and minimum complexity, and
setting the learning rate to decrease quickly with an increase in the number of learning repetitions when the complexity of the subnet is relatively low.

15. The supernet learning method according to claim 11,
wherein the step of setting a learning rate includes
calculating a learning reduction coefficient that controls speed of decrease of the learning rate for the subnet according to the complexity of the subnet, and
dynamically adjusting and setting the learning rate according to the number of learning repetitions using the learning reduction coefficient.

16. The supernet learning method according to claim 15,
wherein the step of setting a learning rate includes
setting the learning rate η^{t} according to Equation
$${η}^{t} = {η}^{0} \cdot {( 1 - \frac{t}{T} )}^{γ ( α )}$$
where, T represents a total number of learning repetitions, t represents the number of learning repetitions, η⁰ represents an initial learning rate, and γ(α) represents the learning reduction coefficient.

17. The supernet learning method according to claim 15,
wherein the step of setting a learning rate includes
calculating the learning reduction coefficient γ(α) according to the complexity C(α) of the subnet α according to Equation
$$γ ( α ) = ωlog ( 𝒞 ( α ) ) + τ$$
where, ω and η represent normalization weight and normalization bias.

18. The supernet learning method according to claim 17,
wherein the step of setting a learning rate includes
calculating the normalization weight ω according to Equation
$$ω = - \frac{{γ}_{max} - {γ}_{min}}{log ( {𝒞}_{max} ) - log ( {𝒞}_{min} )}$$
where, Cₘₐₓ and Cₘᵢₙ represent the maximum complexity and minimum complexity of subnets being extracted, and γₘₐₓ and γₘᵢₙ represent the maximum learning reduction coefficient and minimum learning reduction coefficient set for the learning reduction coefficient.

19. The supernet learning method according to claim 17,
wherein the step of setting a learning rate includes
calculating the normalization bias τ according to Equation
$$τ = {γ}_{min} - ωlog ( {𝒞}_{max} )$$
where, Cₘₐₓ represents the maximum complexity among the complexities of extracted multiple subnets, and γₘᵢₙ represents the minimum learning reduction coefficient set for the learning reduction coefficient.

20. The supernet learning method according to claim 11,
wherein the step of obtaining the trained supernet includes,
when the supernet is divided into multiple sub-supernets, and subnets are extracted from each of the divided multiple sub-supernets,
merging the subnets to obtain multiple trained sub-supernets, and merging the multiple trained sub-supernets again to obtain the trained supernet.
